(19) United States
(12) Patent Application Publication
(10) Pub. No.: US 2026/0140072 A1
(43) Pub. Date: May 21, 2026

(54) X-RAY INSPECTION DEVICE AND ARTICLE INSPECTION SYSTEM

(71) Applicant: ANRITSU CORPORATION, Kanagawa (JP)

(72) Inventors: Akira OHASHI, Kanagawa (JP); Michihiko IKEDA, Kanagawa (JP)

(21) Appl. No.: 19/365,417

(22) Filed: Oct. 22, 2025

(30) Foreign Application Priority Data
Nov. 19, 2024 (JP) 2024-201721

(51) Int. Cl. G01N 23/083; G01N 23/10

(52) U.S. Cl. CPC G01N 23/083; G01N 23/10; G01N 2223/618; G01N 2223/639; G01N 2223/643

(57) ABSTRACT

An X-ray inspection device performs relative mass inspection of an inspection object based on an X-ray inspection image obtained by X-ray imaging the inspection object at a predetermined transport position, and includes: a morphological feature imaging unit that images an appearance of the inspection object and outputs appearance image data including classifiable morphological features of the inspection object; a variant feature image recognition unit that detects an image feature value for each variant, by which a content component type of the inspection object is specifiable, from the appearance image data; and an inspection control unit that varies specific inspection parameters for the relative mass inspection in accordance with the image feature value for each variant recognized by the variant feature image recognition unit.

### TECHNICAL FIELD

The present invention relates to an X-ray inspection device and an article inspection system, and particularly to an X-ray inspection device that can measure at least the relative mass of an inspection object based on an intensity (transmission amount) of X-rays transmitted through the inspection object and a distribution of the transmission amount, and an article inspection system including the same.

### BACKGROUND ART

In the related art, an X-ray inspection device having a function of measuring the relative mass of an inspection object or measuring the volume of the inspection object based on a measurement value of a transmission amount of X-rays transmitted through the inspection object for each unit transmission region (hereinafter, simply referred to as a relative mass measurement function) or an article inspection system including the same is known.

As such an X-ray inspection device having the relative mass measurement function or the article inspection system, for example, an X-ray inspection device or an article inspection system that irradiates a measurement object located between an X-ray generation unit and an X-ray detection unit with X-rays from the X-ray generation unit, detects a transmission amount of the X-rays transmitted through the measurement object via the X-ray detection unit, calculates a mass thickness of the measurement object for each unit transmission region (mass thickness of a material constituting the unit transmission region=density ρ×thickness x) based on a distribution of the detected transmission amount of the X-rays or a distribution of an absorption amount corresponding to the detected transmission amount of the X-rays, integrates the mass thickness for each unit transmission region, and calculates the mass of the entire inspection object corresponding to the integrated value of the mass thicknesses of all the transmission regions is known (for example, see Patent Document 1).

A relative mass measurement method in the article inspection system is based on the following idea. That is, when the X-rays with incident intensity I₀ are attenuated by absorption while passing through the material and are detected by the X-ray detection unit after transmission, intensity I of the detected X-rays decreases exponentially relative to the incident intensity I₀ in accordance with the intrinsic mass absorption coefficient μₘ of the material (=material's linear absorption coefficient μ/density ρ) and the mass thickness (=density ρ×thickness x) of the material, so that the intensity I can be represented by Expression [11], and a mass thickness ρ·x of the material can be represented by Expression [12] based on a logarithmic attenuation corresponding to an X-ray transmittance (ratio I/I₀ of X-ray intensity before and after transmission) and the mass absorption coefficient μₘ of the material.

$$I = {I}_{0} \cdot {e}^{- μ m \cdot ρ \cdot x} \qquad [ 11 ]$$

$$ρ \cdot x = - ( 1 / {μ}_{m} ) \cdot ln ( I / {I}_{0} ) \qquad [ 12 ]$$

As another X-ray inspection device in the related art having the relative mass measurement function, for example, an X-ray inspection device that performs processing of converting density data of an X-ray image in each transmission region to density data of an equivalent thickness image corresponding to a thickness of an inspection object in each transmission region, measures the volume of the inspection object in each of a plurality of transmission regions based on the density data of the equivalent thickness image corresponding to each of the plurality of transmission regions, and measures mass of the inspection object by converting the volume measurement value measured for each of the transmission regions into a conversion value in mass units at a conversion ratio set in advance is known (for example, see Patent Document 2).

### RELATED ART DOCUMENT

### Patent Document

[Patent Document 1] JP-A-2002-296022
[Patent Document 2] JP-A-2006-300887

### DISCLOSURE OF THE INVENTION

### Problem that the Invention is to Solve

However, in the X-ray inspection device in the related art having the relative mass inspection function and the article inspection system as described above, in a case where a plurality of variants of similar articles having substantially the same shape but different content components are manufactured and inspected on the same manufacturing line, in order to perform the high-accuracy relative mass inspection that can also cope with a slight difference in the content components, it is necessary to read identification information such as label display for each variant having different content components, to understand the difference in the content components from other variants of similar articles, and to perform the determination of the necessary inspection parameters of the inspection object or any necessary setting changes. Therefore, there is a problem that it takes time and effort to frequently change the settings of the inspection parameters when the variant is frequently switched or when a plurality of variants are mixed and flow.

Meanwhile, in a case where a plurality of variants of similar articles having the same shape but different content components are manufactured and inspected on the same manufacturing line, when the above-described setting of the inspection parameters for high-accuracy relative mass measurement for each variant is omitted, there is a concern that an error of the relative mass measurement value increases due to inappropriate setting, and the accuracy of the mass inspection deteriorates.

Further, in a case where a plurality of variants of similar articles having different content components are consumer products, a consumer can easily and quickly identify a product desired to be purchased by using partial differences in package display or a visually recognizable product morphology as a feature point even without carefully checking the identification information in the label display or the like in many cases, but such a difference in the feature point has not been effectively utilized for the setting change of the inspection parameters described above.

The present invention has been made in order to solve the above-described unresolved problems in the related art, and an object of the present invention is to provide an X-ray inspection device that can perform high-accuracy relative mass inspection on a plurality of variants of similar inspection objects with different content components on the same line without the need to change variant settings, and an article inspection system including the same.

### Means for Solving the Problem

(1) In order to achieve the above-described object, the present invention provides an X-ray inspection device that performs relative mass inspection of an inspection object based on an X-ray inspection image obtained by imaging the inspection object transported in a predetermined direction by transmission of X-rays at a predetermined transport position, the X-ray inspection device including: a morphological feature imaging unit (for example, a visible light camera) that images the inspection object and outputs classification image data including classifiable morphological features of the inspection object; a variant feature image recognition unit that detects an image feature value for each variant, by which a content component type of the inspection object the is specifiable, from classification image data; and an inspection control unit that varies specific inspection parameters for the relative mass inspection in accordance with the image feature value for each variant recognized by the variant feature image recognition unit.

With this configuration, in the X-ray inspection device, the inspection object is imaged by transmission of X-rays at the predetermined transport position to generate the X-ray inspection image, and the relative mass inspection of the inspection object is performed based on the X-ray inspection image, while the inspection object is imaged by the morphological feature imaging unit such as the visible light camera, and the classification image data is output. Then, the image feature value for each variant by which the content component type of the inspection object is specifiable is detected from the classification image data by the variant feature image recognition unit, and the specific inspection parameters for the relative mass inspection in the X-ray inspection device are varied by the inspection control unit in accordance with the image feature value for each variant. Accordingly, for example, in a case where the products as the inspection object have substantially the same shape, and a package color indicating a package type, a product image, and a product-type indication are apart from visually discernible identification information such as product-identification labels, the products can be identified from the same viewpoint as consumers, and the inspection parameters can be set or changed in accordance with the identification result. As a result, even in a case where the shapes of a plurality of variants of similar inspection objects have the same or similar shapes and the content component indication of the inspection object on the manufacturing line is difficult to visually confirm from above or from the side, effective variant identification and rapid, accurate setting of the inspection parameters based on the identification result can be readily achieved without the setting operation becoming time-consuming. In addition, since the image feature value for each variant is detected from the classification image data, it is not necessary to provide reading means for identification code or text information.

(2) In the preferred embodiment of the present invention, in a case where a plurality of inspection objects are transported in the predetermined direction, the morphological feature imaging unit may image each of the inspection objects and output classification image data of each of the inspection objects, the variant feature image recognition unit may detect an image feature value for each variant of each of the inspection objects from the classification image data of each of the inspection objects, and the inspection control unit may dynamically vary specific inspection parameters for each variant for the relative mass inspection of each of the inspection objects by the X-ray inspection device in accordance with the image feature value for each variant of each of the inspection objects recognized by the variant feature image recognition unit.

In this case, in a case where a plurality of inspection objects of the same variant are transported in sequence, the setting of the specific inspection parameters for the variant is maintained, while in a case where a plurality of inspection objects of different variants are transported in sequence, the setting can be made from the specific inspection parameters for the relative mass inspection of a preceding variant, which is previously identified by the variant feature image recognition unit in accordance with the image feature value for each variant of the inspection object of a preceding first variant (hereinafter, also simply referred to as preceding variant), to the specific inspection parameters for the relative mass inspection of a subsequent variant, which is identified by the variant feature image recognition unit in accordance with the image feature value for each variant of the inspection object of a subsequent second variant (hereinafter, also simply referred to as subsequent variant), before the relative mass inspection is performed by the X-ray inspection device based on the X-ray inspection image which is created when the inspection object of the subsequent variant reaches the predetermined transport position. Therefore, even in a case where the switching of the variant is performed or a plurality of variants are mixed and pass through an inspection line, the setting of the specific inspection parameters for each variant can be readily performed quickly and accurately without the setting operation becoming time-consuming.

(3) The variant feature image recognition unit may detect the image feature value for each variant, by which the content component type of the inspection object is specifiable, from the classification image data by using an object detection method, and the inspection control unit may recognize the variant of the inspection object based on the image feature value for each variant, and vary the specific inspection parameters for the relative mass inspection in accordance with the content component type of the inspection object specified by the variant.

In this case, since the image feature value for each variant can be detected from the classification image data by using the object detection method, the position, the number, and the like of the image element (object) contributing to the identification of the variant can also be effectively utilized for the variant identification. The object detection method referred to herein is, for example, a method using a neural network or a method using a rule-based object detection algorithm.

(4) The variant feature image recognition unit may detect an image of a two-dimensional code from the classification image data, and the inspection control unit may recognize the variant of the inspection object by performing predetermined code reading processing of reading the two-dimensional code, and vary the specific inspection parameters for the relative mass inspection in accordance with the content component type of the inspection object specified by the variant. The specific inspection parameters may be a correction exponent corresponding to X-ray intensity that attenuates exponentially during transmission through a material and a reference value of actual weight.

In this case, in a case where the two-dimensional code can be read as the image feature value for each variant from the classification image data, the variant can be identified from the two-dimensional code, and the specific inspection parameters are varied by using the identification result.

(5) The present invention provides an article inspection system including: the X-ray inspection device according to (1) or (2), in which the morphological feature imaging unit is mounted on an appearance inspection device disposed upstream of the X-ray inspection device, and the classification image data, including the classifiable morphological features of the inspection object, transmitted as output from the appearance inspection device is received as input by the inspection control unit of the X-ray inspection device.

With this configuration, in the article inspection system according to the present invention, in a case where the classification image data of the inspection object transmitted as output from the appearance inspection device is received as input to the inspection control unit of the X-ray inspection device, the image feature value for each variant of the inspection object is detected from the classification image data by the variant feature image recognition unit, and the specific inspection parameters for the relative mass inspection in the X-ray inspection device are varied by the inspection control unit in accordance with the image feature value for each variant. Therefore, it is not necessary to set a dedicated appearance imaging unit in the X-ray inspection device, and it is possible to reduce the system cost.

### Advantage of the Invention

According to the present invention, it is possible to provide the X-ray inspection device that can perform high-accuracy relative mass inspection on a plurality of variants of similar inspection objects with different content components on the same line without the need to change the variant settings, and the article inspection system including the same.

### BRIEF DESCRIPTION OF THE DRAWINGS

FIG. 1 is a schematic configuration diagram of an X-ray inspection device according to an embodiment of the present invention.

FIG. 2 is a block configuration diagram of a relative mass measurement t function unit in the X-ray inspection device shown in FIG. 1.

FIG. 3A shows a first parameter setting table in which brightness P₀ indicating an image density of the background, brightness P₁ indicating an image density of the foreground, and unsaturated maximum brightness Qmax indicating the image density of the background are set as typical setting examples of parameters set by an inspection control unit in the X-ray inspection device according to the embodiment of the present invention, and FIG. 3B shows a second parameter setting table in which a correction exponent γ in Expression [11] indicating an exponential decrease degree of transmission X-ray intensity with respect to irradiation intensity for each type of a product and weight of a measurement reference article of the type are set.

FIG. 4A is a diagram showing a relative mass inspection result of a plurality of inspection objects in a case where the inspection parameters are varied in accordance with the variant in the X-ray inspection device according to the embodiment of the present invention, in which a vertical axis indicates a difference between actual weight and a measurement value, and a horizontal axis indicates the actual weight of each inspection object, and FIG. 4B is a diagram showing a relative mass inspection result of a comparative example corresponding to a case where the inspection parameters are not set in accordance with the variant in the X-ray inspection device according to the embodiment of the present invention, in which a vertical axis indicates a difference between actual weight and a measurement value, and a horizontal axis indicates the actual weight of each inspection object.

FIG. 5 is a schematic configuration diagram of an article inspection system including the X-ray inspection device according to another embodiment of the present invention.

### BEST MODE FOR CARRYING OUT THE INVENTION

Hereinafter, an embodiment according to the present invention will be described with reference to the drawings.

### Embodiment

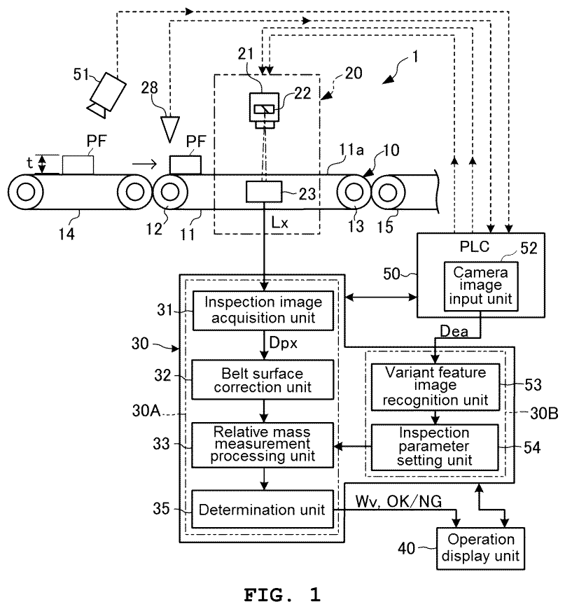

FIGS. 1 to 4 show an X-ray inspection device according to the embodiment of the present invention.

First, a configuration of the X-ray inspection device will be described.

An X-ray inspection device 1 shown in FIG. 1 includes an article transport unit 10, an X-ray imaging unit 20, an inspection control unit 30, an operation display unit 40, and a programmable logic controller (PLC) 50, and has an upstream conveyor 14 provided upstream of the article transport unit 10 as an inspection conveyor and a downstream conveyor 15 provided downstream of the article transport unit 10 and provided with a sorting device (not shown) or the like.

The article transport unit 10 as an inspection conveyor transports an inspection object PF (article) in a right direction (transport direction) in FIG. 1, and, for example, by driving, by a motor, any of rollers 12 and 13 over which a loop-shaped inspection belt 11 is laid, the inspection object PF on a transport path 11a, which is an upper running section of the belt, is transported to a certain speed, and the inspection object PF passes through an inspection region of the X-ray imaging unit 20. In the present embodiment, the article transport unit 10 is a belt conveyor in which any of the rollers 12 and 13 is driven by the motor, and the transport path 11a is flat. However, the article transport unit 10 may instead be of a type that pressure-feeds the inspection object PF through a tubular transport path, or a type in which the inspection object PF passes through the inspection region under its own weight.

The inspection object PF is not particularly limited, and examples thereof include retort foods in which food is enclosed by closing a packaging film into a bag shape by vapor deposition, heat sealing, or the like such as a plurality of types of curry differing in spiciness or ingredients and small processed foods in which multiple kinds of jelly-like foods are enclosed by closing a packaging film into an elongated, flat tube shape by vapor deposition, heat sealing, or the like such as pet food of a size that can be grasped with the fingertips.

The X-ray imaging unit 20 has an X-ray generator 21 and an X-ray detector 23 disposed with the transport path 11a of the article transport unit 10 interposed therebetween. The X-ray generator 21 and the X-ray detector 23 are disposed to face each other in the vertical direction while being spaced apart above and below in the vertical direction, but the X-ray generator 21 and the X-ray detector 23 may be disposed to be spaced apart from each other in both the vertical direction and the horizontal direction.

Although not shown in detail, the X-ray generator 21 includes, for example, an X-ray tube 22 inside a metal housing, and has a configuration in which the X-ray tube 22 is immersed in insulating oil for cooling inside the housing. The X-ray generator 21 is an X-ray irradiation unit that irradiates a predetermined inspection region of the inspection object PF in the transport path 11a with X-rays, and, in the present embodiment, the X-ray generator 21 includes the X-ray tube 22 that irradiates the inspection object PF with X-rays from an upper side to a downward side in the vertical direction.

The X-ray tube 22 is disposed, for example, with its axial direction oriented substantially parallel to a predetermined transport direction, and is configured such that, on a cathode side, a DC negative potential is applied to a filament heated to a high temperature to emit electrons, which are focused by a focusing electrode, and, on an anode side, a DC positive potential is applied to a target so that electrons from the filament are accelerated by a high voltage to strike the target, thereby generating the X-rays in a predetermined energy range from the target.

Accordingly, the X-rays generated by the X-ray tube 22 are emitted downward from an X-ray window portion on the bottom side of the housing toward the inspection region into which the inspection object PF is carried, as a fan beam that spreads in a line-scanning direction orthogonal to the transport direction. The anode of the X-ray tube 22 may be either a fixed type or a rotating type.

The X-ray imaging unit 20 also includes a filament power supply circuit (not shown) and a high-voltage circuit that applies a high voltage between the filament of the X-ray tube 22 and the target.

The X-ray detector 23, although not shown in detail, is disposed, for example, directly below the transport path 11a of the inspection belt 11, and is configured as a line sensor having a scintillator that emits light upon absorbing the X-rays of a predetermined energy (wavelength/transmission power) and a photodiode array composed of N (for example, several hundred) light-receiving elements arranged in a direction orthogonal to the transport direction of the inspection object PF to receive the light (scintillation light) from the scintillator. The X-ray detector 23 absorbs the X-rays emitted to and transmitted through the inspection object PF by a scintillator, emits light in accordance with the transmission intensity of the X-rays, and outputs an electrical signal corresponding to an amount of light received by the photodiode for each predetermined scanning period. It goes without saying that the X-ray detector 23 is not limited to an indirect conversion type that indirectly converts the X-rays into the electrical signal, and may be a direct conversion type.

The photodiode array of the X-ray detector 23 accumulates, for a predetermined integration time, the photocurrents generated simultaneously by the N light-receiving elements, and outputs a brightness detection signal Lx, which is a voltage signal, based on the charge proportional to the product of the photocurrent and the integration time.

Although not shown in detail, the inspection control unit is hardware-configured with, for example, a microcomputer having a CPU, a ROM, a RAM, and an I/O interface, an auxiliary storage device that, in cooperation with the ROM, stores control programs for implementing the various functions so as to be readable, and timer circuits, driver circuits, and the like. In accordance with software such as the control programs and setting information stored in the ROM, the CPU executes predetermined arithmetic processing while exchanging data with the RAM and executes the control programs. The hardware may include a field programmable gate array (FPGA), a digital signal processor (DSP), or the like. In addition, the various functions referred to herein are functions of respective functional units and means for the X-ray output control, the generation of the X-ray image data, the inspection control, the display output control, and the like described later.

The inspection control unit 30 has a transport control function of controlling the transport speed or the transport interval of the inspection object PF by the inspection belt 11 in the article transport unit 10, and an inspection control function of controlling the X-ray irradiation intensity or irradiation period in the X-ray imaging unit 20, or controlling the X-ray detection period in the X-ray detector 23 and the detection period of each inspection object PF in accordance with the transport speed of the inspection object PF. The configuration of the transport control function unit is the same as that in the related art, and thus detailed illustration thereof will be omitted here.

As shown in FIG. 1, the inspection control unit 30 includes a relative mass measurement function unit 30A and a variant parameter fitting function unit 30B. The relative mass measurement function unit 30A includes an inspection image acquisition unit 31, a belt surface correction unit 32, a relative mass measurement processing unit 33, and a determination unit 35, and the variant parameter fitting function unit 30B includes a variant feature image recognition unit 53 and an inspection parameter setting unit 54.

Specifically, the inspection image acquisition unit 31 acquires the brightness detection signal Lx for each line scanning from the photodiode array of the X-ray detector 23 to generate X-ray image data Dpx.

The belt surface correction unit 32 performs, for each of the N light-receiving elements, correction that equalizes the brightness detection signal Lx from the X-ray detector 23 obtained when the X-rays from the X-ray generator 21 pass only through the transport path 11a, which is the belt surface before the inspection object PF is carried in (when no inspection object PF is present) to a white reference value, that is, to perform light-receiving sensitivity correction (so-called shading correction) at the belt surface.

The determination unit 35 is configured, based on the measurement result of the relative mass measurement processing unit 33, to determine whether a mass measurement value Wv of the inspection object PF falls within a predetermined allowable error range with respect to a reference value Wr of its actual weight.

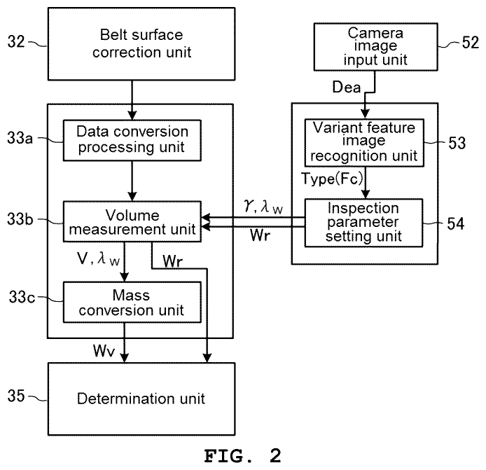

As shown in FIG. 2, the relative mass measurement processing unit 33 includes a data conversion processing unit 33a, a volume measurement unit 33b, and a mass conversion unit 33c.

The data conversion processing unit 33a is data conversion processing means for conversion processing (details will be described later) of converting density data P of each transmission region in the X-ray image data Dpx into density data Q(P) of an equivalent thickness image corresponding to a thickness t of the inspection object PF in the transmission region, and has a conversion processing program and a working memory area for the conversion processing. The equivalent thickness referred to herein is an X-ray equivalent thickness τ (=α·t) corresponding to the linear absorption coefficient α and the thickness t of each portion of the inspection object PF, and is a thickness corresponding to the density value (brightness value) of the X-ray image in an equivalent manner.

Here, the density data Q(P) of the equivalent thickness image is a density value (here, brightness value) obtained by logarithmically converting the density data P of the X-ray image by a conversion expression to be described later to correspond to the X-ray absorption amount, has maximum brightness P₀ when the inspection object PF is not present, the value of the X-ray transmission amount is the maximum, and the X-ray absorption amount of the inspection object PF is zero, and has minimum brightness P₁ when the value of the X-ray transmission amount is the minimum and the X-ray absorption amount of the inspection object PF is the maximum.

When X-rays are emitted toward the inspection object PF, the phenomenon whereby N₀ photons of a predetermined energy are reduced to N by the transmission through the inspection object PF (thickness t, linear absorption coefficient α) and the inspection belt 11 (thickness t0, linear absorption coefficient α0) can be approximated, according to the Beer-Lambert law, by Expression [1].

$$N = {N}_{0} exp ( - α \cdot t - {α}_{0} \cdot {t}_{0} ) \qquad [ 1 ]$$

Further, in an X-ray fan-beam optical system as adopted in the present embodiment, a light-receiving amount I for each pixel within a range of a focal elevation angle (90°−θ) of the X-ray detector 23 consisting of, for example, a scintillator-type CCD line sensor takes a value corresponding to the X-ray irradiation intensity in each transmission region and can be represented as

$$I ( θ ) = \{ 1 / ( 1 + {tan}^{2} θ ) \} \cdot I ( 0 ° ) . \qquad [ 2 ]$$

However, typically, the light-receiving sensitivity correction, that is, the belt-surface correction described above is performed to adjust the detection sensitivity of the X-ray detector 23 so that, on the conveyor belt surface before article is carried in (background image region), the light-receiving amount I(θ) becomes flat at the maximum brightness (white reference), that is, the correction is performed that, with respect to the light-receiving amount I(θ) on the belt surface alone before article is carried in, equalizes the outputs of all sensor elements of the X-ray detector 23 to a predetermined white reference value (maximum brightness).

Accordingly, the light-receiving amount I₀ on the belt surface (background) before the article is carried in after the light-receiving sensitivity correction becomes a constant value corresponding approximately to N₀ exp(−α₀·t₀), and the light-receiving amount I′ in each transmission region, which no longer depends on the angle θ by the light-receiving sensitivity correction of the X-ray detector 23, can be calculated by Expression [3].

$${I}^{′} = {I}_{0} exp ( - α \cdot t ) \qquad [ 3 ]$$

In addition, α·t is a value that directly represents the X-ray absorption amount by the material through which the X-rays pass from the X-ray generator 21 until the detection by the X-ray detector 23, and by mapping this value to the density values of the X-ray absorption image, an image can be created in which materials with higher X-ray absorptivity or regions thicker in the X-ray transmission direction have a larger pixel density value and lower brightness.

Therefore, in a case in which the light-receiving amounts I′ and I₀ described above are used, α·t is defined as the X-ray equivalent thickness t in each transmission region of the inspection object PF, and the correction exponent corresponding to the X-ray intensity (transmission power) that attenuates exponentially during the transmission through the material is denoted by γ, the image density value J(τ) of the X-ray transmission image can be represented by Expression [4].

$$J ( τ ) = {( α \cdot t )}^{Υ} = {\{ ln ( {I}_{0} ) - ln ( {I}^{′} ) \}}^{Υ} \qquad [ 4 ]$$

The data conversion processing unit 33a has a linearity correction function of adjusting the correction exponent γ within a predetermined range set in accordance with the inspection object PF and correcting the linearity of the density data of the equivalent thickness image corresponding to the thickness t of the inspection object PF to enhance the linearity.

Specifically, the belt surface correction unit 32 and the data conversion processing unit 33a are configured to set and input each of the brightness value P₀ that is the density value of the background in the X-ray image, the brightness value P₁ that is the representative density of the foreground in the X-ray image, and the maximum density Qmax of the equivalent thickness image, and to perform the conversion processing of converting the density data P of the X-ray image into the density data Q(P) of the equivalent thickness image in each transmission region of the inspection object PF based on the set values, using Expression [5].

$${Q ( P ) = [ ( ln ( {P}_{0} ) - ln ( P ) ] / \{ ln ( {P}_{0} ) - ln ( {P}_{1} ) \} ]}^{Υ} \cdot Q max \qquad [ 5 ]$$

$$Here , Q ( P ) : density value in equivalent thickness image for transmission region at maximum thickness of workpiece , corresponding to Q ( P a )$$

$$P a : density value in X - ray image for transmission region at maximum thickness of workpiece$$

$${P}_{0} : density value of background in X - ray image$$

$${P}_{1} : representative density value of foreground in X - ray image of representative workpiece$$

$$Υ : correction exponent$$

$$Q max : maximum density value of equivalent thickness image$$

The density data Q(P) of the equivalent thickness image is a value after logarithmic conversion corresponding to the density J(τ) of a distribution image of the equivalent thickness τ described above, and is further subjected to the light-receiving sensitivity correction on the belt surface.

In addition, the correction exponent γ is adjusted within a predetermined range corresponding to the type of the inspection object PF. By performing the correction of adjusting the correction exponent γ in this range, even in a case where the X-ray inspection is performed on many foods as the inspection object PF, good linearity of the density data Q(P) of the equivalent thickness image with respect to the thickness t of the inspection object PF in each transmission region can be ensured.

The data conversion processing unit 33a sets, based on the X-ray image density value Pa (brightness value) in a specific transmission region of a representative workpiece serving as the standard for the inspection object PF, the density value Q(Pa) of the equivalent thickness image calculated by Expression [5] as a value Qa represented by Expression [6] (Qa=Q(Pa)); and, using the calculated equivalent thickness image density value Q(Pa) and the X-ray image density value Pa in the specific transmission region of the representative workpiece (for example, the X-ray image density of the transmission region corresponding to the maximum thickness), and then preliminarily calculates the density value P₂ in Expression [6], which is the representative density value of the foreground in the X-ray image of the representative workpiece.

$${Q ( P ) = [ ( ln ( {P}_{0} ) - ln ( P a ) ] / \{ ln ( {P}_{0} ) - ln ( {P}_{2} ) \} ]}^{Υ} \cdot Q max \qquad [ 6 ]$$

$$Here , Q ( P ) : density value in equivalent thickness image for transmission region at maximum thickness of workpiece , corresponding to Q ( P a )$$

$$P a : density value in X - ray image for transmission region at maximum thickness of workpiece$$

$${P}_{0} : density value of background in X - ray image$$

$${P}_{2} : representative density value of foreground in X - ray image of representative workpiece$$

$$Υ : correction exponent$$

Then, using the density value P₂ (brightness value) calculated here, a setting is made update the representative density value P₁ of the foreground in Expression [5], and thereafter the conversion processing is executed to convert, for each transmission region, the density data P of the X-ray image into the density data Q(P) of the equivalent thickness image having the density corresponding to the thickness t of the inspection object PF.

Here, the representative workpiece for the inspection object PF is a typical good (non-defective) workpiece, and the representative workpiece passes through the inspection space once to calculate the density value P₂ in Expression [6], and, using the expression obtained by substituting this calculated value for P₁ in Expression [5], the conversion processing can be performed to convert the density data P of the X-ray image into the density data Q(P) of the equivalent thickness image for each inspection object PF.

In addition, the data conversion processing unit 33a has a data look-up table (not shown) that defines conversion conditions and a processor that performs the data conversion processing using the conversion table, and in the look-up table, density levels of the density data Q(P) of the equivalent thickness image, which are the results of the conversion processing, are stored in association with the density levels of the density data P of the X-ray image in a plurality of stages.

The volume measurement unit 33b performs processing of calculating volume V of the inspection object PF by summing up the density data Q(P) of the equivalent thickness image corresponding to each of a plurality of transmission regions for the entire measurement range of each inspection object PF, and has a measurement processing program and a working memory area for this purpose.

In addition, the volume measurement unit 33b performs the volume calculation only for the transmission region in which the density level of the density data Q(P) of the equivalent thickness image is equal to or greater than a predetermined noise cut threshold among the plurality of transmission regions on the scanning line of the X-ray detector 23, and the volume measurement unit 33b can calculate the volume V of each inspection object PF by summing only valid data among the density data Q(P) (hereinafter, also referred to as slice data) of the equivalent thickness image obtained in each scanning from a leading end to a trailing end of the inspection object PF in the transport direction.

The mass conversion unit 33c has a conversion processing program for converting the volume measurement value V for each transmission region measured by the volume measurement unit 33b into a conversion value (mass) in mass units at a predetermined conversion ratio (conversion rate) set in advance, a coefficient holding memory area for storing a mass conversion coefficient Aw of the inspection object PF read from a variant parameter file (not shown) and the like, and a working memory area for the conversion processing.

Here, in a case where the volume measurement value V of a certain inspection object PF is multiplied by the mass conversion coefficient λ_{W} depending on the variant of the inspection object PF, the volume measurement value V of the inspection object PF can be converted into a value Wv in mass units. In a case where the value converted into mass units is denoted by Wv, the conversion value Wv can be represented as Wv=λ_{W}·V.

In addition, the operation display unit 40 is connected to the determination unit 35 (may be the mass conversion unit 33c), and the mass conversion value Wv of the inspection object PF converted into mass units by the mass conversion unit 33c or the volume measurement result V of the inspection object PF before the conversion is output to the operation display unit 40.

The determination unit 35 further incorporates a program that determines pass or fail of the mass measurement result by determining whether the conversion value Wv of the volume measurement value V of the inspection object PF converted into a value in mass units is within a predetermined allowable range with respect to a predetermined mass reference value Wr, and thus the determination unit 35 can obtain the pass/fail information OK/NG of the mass measurement result for each inspection object PF and output the pass/fail information OK/NG and the mass conversion value Wv of the inspection object PF to the operation display unit 40.

Meanwhile, a visible light camera 51 (morphological feature imaging unit) that images the appearance of the inspection object PF, for example, with visible light and outputs appearance image data Dea (classification image data, see FIG. 2) including the classifiable morphological features of the inspection object PF, from a position upstream of a predetermined transport position of the inspection object PF, for example, a position at which the inspection object PF is carried into the X-ray imaging unit 20, which is detected by the article detection sensor 28 such as a photoelectric sensor is provided above the upstream conveyor 14 upstream of the article transport unit 10 (inspection conveyor). While the visible light camera 51 performs appearance imaging using visible light, in order to visualize, from another viewpoint, the classifiable morphological features of the inspection object PF, particularly changes in variant features, that are difficult to grasp by X-ray imaging, a near-infrared camera, a multispectral camera, or the like may also be provided. In addition, the imaging timing of the inspection object PF by the visible light camera 51 or an alternative morphological feature imaging unit is not particularly limited, and may be made simultaneous with imaging by the X-ray imaging unit 20.

The “classifiable morphological features” of the inspection object PF are morphological features that enable classification even where a plurality of inspection objects PF each have substantially the same shape, and that indicate distinctions of a plurality of types within such classification such as package color, images of the contents, or product type indications as parts of the appearance, which further include morphological features identifiable by human senses other than sight, such as touch, and are morphological features that, separately from identification information such as product-identification labels, contribute to classification and varietal identification.

The visible light camera 51 is connected to the PLC 50, and the appearance image data Dea from the visible light camera 51 is taken into the variant parameter fitting function unit 30B of the inspection control unit 30 via a camera image input unit 52 in the PLC 50. Although not shown, a tablet-type information terminal that functions as a programming tool or a setting input switch can be provided together with the PLC 50.

The PLC 50 stores, for example, a control procedure for controlling the X-ray irradiation drive of the X-ray imaging unit 20, the detection drive of the X-ray detector 23, the input of the article detection signal from the article detection sensor 28, the transport drive of the article transport unit 10, and the like via respective drive circuits (not shown) as a program list for sequence control in advance, drives, in accordance with the control procedure, the transport drive circuit of the article transport unit 10, the X-ray irradiation drive circuit, the detection drive circuit, and the like of the X-ray imaging unit 20 during the operation of the X-ray inspection device 1, and captures the article detection information from the article detection sensor 28 and the appearance image data Dea from the visible light camera 51 to perform timely X-ray imaging of each inspection object PF passing through the inspection section of the X-ray imaging unit 20 during the operation and imaging of the morphological features of the inspection object PF that can be classified by the visible light camera 51.

During the operation of the X-ray inspection device 1, the inspection control unit 30 acquires the brightness detection signal Lx for each line scanning from the photodiode array of the X-ray detector 23 by the relative mass measurement function unit 30A to generate the X-ray image data Dpx, and exhibits the relative mass measurement function based on the X-ray image data Dpx.

Meanwhile, the variant parameter fitting function unit 30B of the inspection control unit 30 detects the image feature value of the variant feature on the appearance, which exhibits a function of classifying the inspection object PF and identifying the variant by the variant feature image recognition unit 53, based on the appearance image data Dea from the visible light camera 51. Then, in a case where the image feature value Fc of the variant feature on the appearance recognized by the variant feature image recognition unit 53 is sent to the inspection parameter setting unit 54, specific inspection parameters for the relative mass measurement processing unit 33 that is in charge of the relative mass inspection function of the X-ray imaging unit 20 are varied by the inspection parameter setting unit 54.

The variant of the inspection object PF referred to herein is variant information by which the content component type of the inspection object PF is specifiable, and corresponds, when a plurality of product types (variants) share the same or similar appearance shape and belong to the same classification (the same at a major classification level), to one of those types (item group of the same type at a sub-classification level). In addition, the classification referred to herein is a product classification for the plurality of inspection objects PF that can be manufactured on the same manufacturing line during the same period and, although including a plurality of types (variants) differing in content components, constitute a product group whose appearance shapes are the same or similar, and also encompasses the classification of those that share classifiable morphological features common thereto.

More specifically, in a case where the plurality of inspection objects PF are transported in a predetermined direction by the article transport unit 10, the visible light camera 51 images each of the plurality of inspection objects PF, and the appearance image data Dea of each inspection object PF is output from the camera image input unit 52 of the PLC 50 to the variant feature image recognition unit 53 of the inspection control unit 30.

When the variant feature image recognition unit 53 detects the image feature value Fc of the variant feature on the appearance of the inspection object PF from the appearance image data Dea of each inspection object PF, the inspection parameter setting unit 54 that takes in the image feature value Fc recognizes the classification and the type (indicated by type (Fc) in FIG. 2) of each inspection object PF imaged by the X-ray imaging unit 20 in accordance with the image feature value Fc for each variant of the inspection object PF recognized by the variant feature image recognition unit 53, and varies specific inspection parameters for each variant for the relative mass measurement function, for example, the correction exponent γ and the reference value (measurement reference article) Wr of the actual weight.

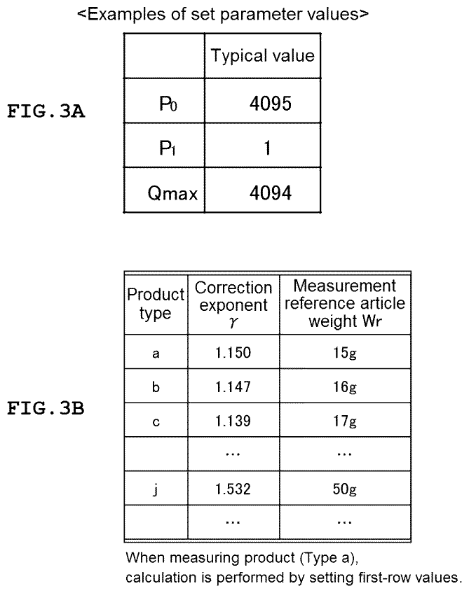

For such setting processing, as shown in the first parameter setting table shown in FIG. 3A, the inspection parameter setting unit 54 stores and holds, as the set values, a typical value of each of the inspection parameters common to the plurality of variants, such as the brightness P₀ corresponding to the maximum brightness indicating the image density of the background in the X-ray image data Dpx, the brightness P₁ corresponding to the minimum brightness indicating the image density of the foreground such as the inspection object PF in the X-ray image data Dpx, and the unsaturated maximum brightness Qmax indicating the image density of the background.

Furthermore, as in the second parameter setting table shown in FIG. 3B, the inspection parameter setting unit 54 stores, for each product classification of the inspection object PF, preset values of the inspection parameters for each variant such as the correction exponent γ in Expression [11] and the weight of the measurement reference article of the type. Then, for example, in a case where any one of a plurality of product types a, b, c, . . . j, . . . of the inspection object PF in FIG. 3B is selected, the inspection parameters for each variant, such as the correction exponent Y corresponding to the variant of the selected type and the weight Wr of the measurement reference article of the selected type, are set. The weight Wr of the measurement reference article referred to herein is weight corresponding to the relative mass value Wv of the measurement reference article for each type (variant) in which the volume V or the material is known, and the mass conversion coefficient λ_{W} for each variant is also set for each type by setting the weight Wr.

The visible light camera 51 is an appearance imaging unit as a morphological feature imaging unit that is installed alone here, but may be mounted on an appearance inspection device or the like disposed upstream of the X-ray imaging unit 20, and the appearance image data Dea of the inspection object transmitted as output from the exterior inspection device can be received as input to the inspection control unit 30 of the X-ray imaging unit 20.

In the variant parameter fitting function unit 30B of the inspection control unit 30, the variant feature image recognition unit 53 detects the image feature value Fc for each variant, by which the content component type of the inspection object PF is specifiable, from the appearance image data Dea of the inspection object PF, by using an object detection method using a neural network, recognizes the variant of the inspection object PF based on the image feature value Fc for each variant, and dynamically varies the specific inspection parameters for the relative mass inspection in the X-ray imaging unit 20, for example, the correction exponent γ, the mass conversion coefficient Aw, and the reference value (measurement reference weight) Wr of the actual weight, in accordance with the content component type of the inspection object PF specified by the variant.

The object detection method using a neural network referred to herein is an object detection method that acquires an object detection algorithm by AI learning using a neural network, for example, an object detection method known as You Only Look Once (YOLO) or Single Shot Detector (SSD), and the product classification and the variant of the inspection object PF can be recognized by detecting the image feature value Fc described later from the appearance image data Dea of the inspection object PF by the object detection. However, the object detection method in the present invention is not limited to the object detection method using the neural network, and, as another variation, an object detection method of detecting the image feature value Fc from the appearance image data Dea of the inspection object PF using a rule (logic)-based technique such as pattern matching may be considered.

The variant feature image recognition unit 53 may have a code recognition function of detecting an image of a predetermined two-dimensional code from the appearance image data Dea of the inspection object PF as an additional function, and, in this case, the variant feature image recognition unit 53 can be configured to recognize the variant of the inspection object PF by executing predetermined code reading processing of reading the two-dimensional code, and vary specific inspection parameters for the relative mass inspection by the X-ray imaging unit 20 in accordance with the content component type of the inspection object PF specified by the variant.

The operation display unit 40 is, for example, a touch panel type composed of a liquid crystal display (LCD) or the like, and has both a function of display means and a function of operation input means. The function of the display means is a function of displaying various types of information required in relation to the X-ray inspection, such as the operating state, the setting information, and the like of the X-ray imaging unit 20 on a display screen. In addition, the function of the operation input means is an operation function of manually performing various touch panel operations, for example, a selection operation of the display screen, a mode switching operation of switching between an inspection mode, a setting mode, and another mode, and setting input of various parameters in the setting mode, and is a function of inputting request information in accordance with operation input of a user.

The operation display unit 40 is not limited to a touch panel integrated with the X-ray inspection device 1, and may be provided as a portable tablet-type information terminal, or may be additionally installed, separate from the touch panel integrated with the X-ray inspection device 1, as a display and control panel.

Next, the operation will be described.

In the present embodiment, first, for example, through an automatic setting sequence, the conditions of the article transport unit and the tube voltage of the X-ray tube 22 in the X-ray generator 21 are set based on the setting parameters stored in the first parameter setting table and other inspection parameters common to a plurality of variants.

Next, under predetermined X-ray output conditions of the X-ray generator 21, the light-receiving sensitivity correction (shading correction) on the belt surface is performed, based on the brightness detection signal Lx from the X-ray detector 23 that detects the X-rays within the predetermined energy range, that is, the electrical signals corresponding to the N light-receiving amounts from the photodiode array for each scanning period, so as to equalize the electrical signals, respectively, to the white reference value in accordance with the variant of the inspection object PF and the inspection conditions.

Next, predetermined inspection control is executed in accordance with the selection of the selected product classification or the variant included in the product classification.

In this inspection control processing, first, the classification of products manufactured the same manufacturing line during the same period for the inspection object PF is selected and set, for example, by a classification number or, alternatively, one type among the plurality of similar variants of the inspection objects PF included in the product classification is selected and set, for example by a symbol or number for that type.

Once this selection has been made, the second parameter setting table shown in FIG. 3B is read out in accordance with the selected classification as information on a plurality of similar variants of the inspection objects PF included in the classification, and a list is retrieved for the plurality of variants within the same classification that includes the product types identifiable by the variant feature image, the correction exponent γ in Expression [11] corresponding to each identified type, and the weight of the measurement reference article for the type.

Next, a specific inspection object PF that has reached the appearance imaging position among the plurality of inspection objects PF that are transported while being spaced apart from each other in the predetermined direction to be sequentially put into the inspection space is imaged by the visible light camera 51, and the appearance image data Dea output from the visible light camera 51 is taken into the variant feature image recognition unit 53 of the variant parameter fitting function unit 30B of the inspection control unit 30 via the camera image input unit 52 in the PLC 50.

Then, based on the taken-in appearance image data Dea, the variant feature image recognition unit 53 detects the image feature value Fc of the variant feature on the appearance that exhibits the function of classifying the inspection object PF and identifying the variant, and the image feature value Fc is sent to the inspection parameter setting unit 54.

In this case, in a case where the image feature value Fc is the same as the variant feature of the inspection object PF of the immediately preceding inspection object, specific inspection parameters for the relative mass measurement processing unit 33 that is in charge of the relative mass inspection function of the X-ray inspection device 1 are maintained.

Meanwhile, in a case where the image feature value Fc detected by the variant feature image recognition unit 53 is not the same as the variant feature of the inspection object PF of the immediately preceding inspection object and is a different type, specific inspection parameters for the relative mass measurement processing unit 33 that is in charge of the relative mass inspection function of the X-ray inspection device 1 are varied by the inspection parameter setting unit 54.

That is, the parameters for the inspection control of specifying the inspection conditions set in advance and stored in the relative mass measurement processing unit 33 in accordance with the inspection object variant are updated and set such that the product of the type (variant) corresponding to the image feature value Fc is a target of the relative mass measurement and the inspection in accordance with the image feature value Fc detected by the variant feature image recognition unit 53.

As described above, in the X-ray inspection device 1 according to the present embodiment, the X-ray inspection image Dpx is generated by imaging the inspection object PF by the transmission of the X-rays at the predetermined transport position, and the relative mass inspection of the inspection object PF is executed based on the X-ray inspection image Dpx. Then, in this case, when the inspection object PF is imaged by the visible light camera 51 at the predetermined X-ray imaging position and the appearance image data Dea is output from the visible light camera 51, the image feature value Fc for each variant by which the content component type of the inspection object PF is specifiable is detected by the variant feature image recognition unit 53 based on the appearance image data Dea, and specific inspection parameters for the relative mass measurement function of the X-ray inspection device 1 are varied by the inspection control unit 30 in accordance with the image feature value Fc for each variant.

Accordingly, for example, when in a case where the plurality of inspection objects PF have substantially the same shape, and a package color indicating a package type, a product image, and a product-type indication are visually discernible apart from identification information such as product-identification labels, the products can be identified from the same viewpoint as consumers, and the inspection parameters can be set or changed in accordance with the identification result.

As a result, even when the plurality of similar variants of inspection objects PF have the same or similar package shapes and the content component indications of the inspection objects PF on the manufacturing line are difficult to view from above or from the side, particularly when the inspection objects PF are so small as to be grasped with the fingertips and the content component indications are even harder to identify, effective variant identification and rapid and accurate setting of inspection parameters based on the identification result can be readily performed without the setting operation becoming time-consuming.

In addition, the image feature value Fc for each variant of the inspection object PF may be a combination of a plurality of image features such as package color, images of the contents, and product-type indications, and thus the image feature value Fc can be readily detected from the appearance image data Dea by using the object detection method or the like, without having to restrict the type of information as with means for reading the identification code or the textual information.

Further, in the present embodiment, in a case where the plurality of inspection objects PF are transported in the predetermined direction, the visible light camera 51 can image each of the inspection objects PF and output the appearance image data Dea of each of the inspection objects PF, the variant feature image recognition unit 53 of the inspection control unit 30 can detect the image feature value Fc for each variant of each of the inspection objects PF from the appearance image data Dea of each of the inspection objects PF, and the inspection parameter setting unit 54 of the inspection control unit 30 can dynamically vary the specific inspection parameters for each variant for the relative mass inspection function of each of the inspection objects PF in the X-ray inspection device 1 in accordance with the image feature value Fc of each recognized inspection object PF for each variant.

Therefore, in a case where the plurality of similar inspection objects PF of the same classification but different types are transported in order, before the relative mass inspection is performed by the X-ray inspection device 1 based on the X-ray inspection image Dpx of the inspection object PF of the subsequent variant type, the setting change can be made from the specific inspection parameters for the relative mass inspection of the preceding variant, which is previously identified and set by the variant feature image recognition unit in accordance with the image feature value for each variant of the inspection object PF of the preceding first variant (preceding variant) to the specific inspection parameters for the relative mass inspection for each variant of the inspection object PF (subsequent variant) of the second variant, which is newly recognized by the variant feature image recognition unit 53. Therefore, even immediately after the switching of the variant is performed or even in a case where a plurality of variants are mixed and pass through the inspection line, the setting of the specific inspection parameters for each variant can be readily performed quickly and accurately without the setting operation becoming time-consuming.

In addition, in the present embodiment, the variant feature image recognition unit 53 detects the image feature value Fc for each variant, by which the content component type of the inspection object PF is specifiable, from the appearance image data Dea of the inspection object PF by using the object detection method, and the inspection control unit 30 can vary the specific inspection parameters for the relative mass inspection in the X-ray inspection device 1 in accordance with the content component type of the inspection object PF of the variant recognized based on the image feature value Fc for each variant by the inspection parameter setting unit 54.

Therefore, since the image feature value Fc for each variant can be detected from the appearance image data Dea by using the object detection method, the position, the number, and the like of the image elements (object detection targets) that contribute to the variant identification can also be effectively utilized for the variant identification.

In addition, in a case where a function of detecting the image of the two-dimensional code from the appearance image data of the inspection object PF is added to the variant feature image recognition unit 53, the inspection control unit 30 can recognize the variant of the inspection object PF by executing predetermined code reading processing of reading the two-dimensional code, and vary the specific inspection parameters for the relative mass inspection function of the X-ray inspection device 1 in accordance with the content component type of the inspection object PF specified by the variant. Therefore, the variant can be identified from the two-dimensional code as a part of the image feature value Fc for each variant from the appearance image data Dea, and the specific inspection parameters can be varied by using the identification result.

### Comparison and Verification of Inspection Performance

### Example 1

As the inspection object PF, a plurality of types of jelly-like pet food sealed in a packaging film sealed on three sides in an elongated flat tube shape by heat sealing, with a packaging film formed by vapor deposition was prepared in a product specification that can be grasped in the product classification shown in FIG. 3B, and these inspection objects PF were carried into the X-ray imaging unit 20 while being transported in a mixed state of many variants of the same classification, and immediately before each inspection object PF reached the X-ray imaging position, the specific inspection parameters for each variant for the relative mass measurement function were varied in accordance with the variant (any of types a, b, and c) and the relative mass measurement and the mass inspection were performed.

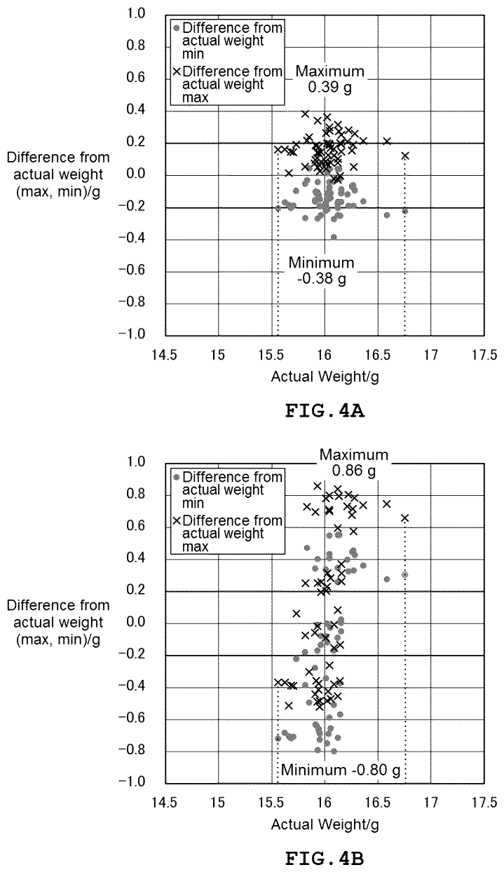

FIG. 4A shows a result (difference from actual weight) of performing the relative mass measurement and the mass inspection by mixing 10 test samples with a slight difference in the actual weight (g) for each type of a plurality of types, for example, six types of the inspection object PF of Example 1, in which a symbol (x) in the same figure indicates the maximum value of the 10 relative mass measurement results of each test sample, and a symbol (●) indicates the minimum value of the 10 relative mass inspection results of each test sample, each value being shown as the value of the difference between the actual weight of each test sample and the relative mass inspection result.

### Comparative Example 1

FIG. 4B shows a result (difference from the actual weight) of performing the relative mass measurement and the mass inspection by mixing 10 test samples with a slight difference in the actual weight (g) for each type of the six types of the inspection object PF, as in Example 1, but shows a result of performing the relative mass measurement and the mass inspection while keeping the specific inspection parameters for each variant for the relative mass measurement function constant regardless of the change in the variant of each inspection object PF.

### Comparison of Measurement Accuracy

The test samples of the plurality of types of the inspection objects PF used for the relative mass measurement of Example 1 and the test samples of the plurality of variants of the inspection objects PF used for the relative mass measurement of Comparative Example 1 were the same. However, in a case of Example 1 in which the specific inspection parameters for each variant for the relative mass measurement function were varied in accordance with the change in the variant of the inspection object PF that reached the X-ray imaging position, as shown in FIG. 4A, it can be seen that the variation in the difference from the actual weight of each of the relative mass measurement results was suppressed to be small. On the other hand, in a case of Comparative Example 1 in which the specific inspection parameters for each variant for the relative mass measurement function were kept constant without being varied regardless of the change in the variant of the inspection object PF that reached the X-ray imaging position, as shown in FIG. 4B, it can be seen that the variation in the difference from the actual weight of each of the relative mass measurement results was large.

As is clear from these results, according to the present embodiment, it is possible to provide the X-ray inspection device 1 that can perform high-accuracy relative mass inspection without the need to change the variant settings even in a case where the plurality of variants of the inspection objects PF having different content components are inspected on the same line.

### OTHER EMBODIMENTS

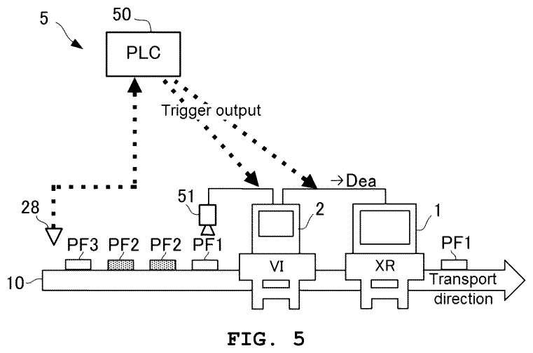

FIG. 5 shows an article inspection system including the X-ray inspection device according to another embodiment of the present invention. Since the present embodiment has a configuration similar to that of the X-ray inspection device 1 according to the present embodiment, in FIG. 5, the same reference numerals as those of the corresponding configurations of the present embodiment shown in FIGS. 1 to 3 will be used for the configuration parts similar to those of the present embodiment.

In the X-ray inspection system 5 according to the present embodiment shown in FIG. 5, the visible light camera 51 is mounted on the appearance inspection device 2 disposed upstream of the X-ray inspection device 1, and the appearance image data Dea of the inspection object PF transmitted as output from the appearance inspection device 2 is received as input to the inspection control unit 30 of the X-ray inspection device 1.

In the present embodiment as well, although the plurality of variants of the inspection objects PF1, PF2, and PF3 having different content components are mixed and inspected on the same inspection line, in the X-ray inspection device 1, the specific inspection parameters for each variant for the relative mass measurement function can be varied in accordance with the change in the type of each of the inspection objects PF1, PF2, and PF3, so that the high-accuracy relative mass inspection can be performed without the need to change the variant settings.

In addition, in the present embodiment, in a case where the appearance image data Dea of the plurality of types of the inspection objects PF1, PF2, and PF3 transmitted as output from the appearance inspection device 2 is received as input to the inspection control unit 30 of the X-ray inspection device 1, the image feature value Fc for each variant of the inspection objects PF1, PF2, and PF3 is detected from the appearance image data Dea by the variant feature image recognition unit 53, and the inspection parameter setting unit 54 of the inspection control unit 30 varies the specific inspection parameters for the relative mass inspection in the X-ray inspection device 1 in accordance with the image feature value Fc for each variant. Therefore, it is not necessary to set a dedicated appearance imaging unit in the X-ray inspection device 1, and it is possible to reduce the cost.

In each of the above-described embodiments, the X-ray detector 23 is the indirect conversion type including the scintillator, but may be a direct conversion type, for example, a photon counting type X-ray detector. In addition, although the visible light camera 51 is described as the morphological feature imaging unit, and the near-infrared camera, the multispectral camera, or the like is provided to visualize the change in the variant of the inspection object PF, which is difficult to grasp in the X-ray imaging, from another viewpoint, in a case where there is a difference in a detailed shape by which the variant can be identified, it is also possible to image the change in the variant of the inspection object PF, which is difficult to grasp with the X-ray used for the X-ray imaging for relative mass measurement, using the X-ray having a different energy intensity from that for the relative mass measurement, so that the variant can be detected.

As described above, the X-ray inspection device according to the present invention can provide the X-ray inspection device that can perform high-accuracy relative mass inspection on a plurality of variants of similar inspection objects with different content components on the same line in a mixed manner without the need to change the variant settings. The present invention is useful for the X-ray inspection device that can measure at least the relative mass of the inspection object based on the intensity (transmission amount) of the X-rays transmitted through the inspection object and the distribution of the transmission amount, and the article inspection system including the same.

### DESCRIPTION OF REFERENCE NUMERALS AND SIGNS

1 X-ray inspection device
2 Appearance inspection device
5 X-ray Inspection System
10 Article transport unit
11 Inspection belt
11a Transport path
12, 13 Roller
14 Upstream conveyor
15 Downstream conveyor
20 X-ray imaging unit
21 X-ray generator
22 X-ray tube
23 X-ray detector
28 Article detection sensor
30 Inspection control unit
30A Relative mass measurement function unit
30B Variant parameter fitting function unit
31 Inspection image acquisition unit
32 Belt surface correction unit (belt surface light-receiving sensitivity correction unit)
33 Relative mass measurement processing unit
33a Data conversion processing unit
33b Volume measurement unit
33c Mass conversion unit
35 Determination unit
40 Operation display unit
50 Programmable logic controller (PLC)
51 Visible light camera (appearance imaging unit, morphological feature imaging unit)
52 Camera image input unit
53 Variant feature image recognition unit
54 Inspection parameter setting unit
a, b, c, j Type (variant)
Dea Appearance image data (classification image data, image of classifiable morphological feature)
Dpx X-ray image data (X-ray inspection image)
Fc Image feature value (classifiable morphological feature)
Lx Brightness detection signal
P Brightness value (density value of X-ray image in each transmission region)
P₀ Brightness value (maximum brightness, density value of equivalent thickness image in X-ray image)
P₁ Representative density of foreground (brightness value, representative density of foreground in X-ray image)
P₂ Density value (representative density value of foreground in X-ray image of representative workpiece, brightness value)
PF, PF1, PF2, PF3 Inspection object
Qmax Maximum density of equivalent thickness image
Q(P) Density data of equivalent thickness image
Q(Pa) Density value of equivalent thickness image (density value of equivalent thickness image of representative workpiece)
Wr Reference value (reference value of actual weight)
Wv Mass measurement value
γ Correction exponent (inspection parameter)

What is claimed is:

1. An X-ray inspection device that performs relative mass inspection of an inspection object based on an X-ray inspection image obtained by imaging the inspection object transported in a predetermined direction by transmission of X-rays at a predetermined transport position, the X-ray inspection device comprising:
a morphological feature imaging unit that images the inspection object and outputs classification image data including classifiable morphological features of the inspection object;
a variant feature image recognition unit that detects an image feature value for each variant, by which a content component type of the inspection object is specifiable, from the classification image data; and
an inspection control unit that varies specific inspection parameters for the relative mass inspection in accordance with the image feature value for each variant recognized by the variant feature image recognition unit.

2. The X-ray inspection device according to claim 1,
wherein, in a case where a plurality of inspection objects are transported in the predetermined direction, the morphological feature imaging unit images each of the inspection objects and outputs classification image data of each of the inspection objects, the variant feature image recognition unit detects an image feature value for each variant of each of the inspection objects from the classification image data of each of the inspection objects, and the inspection control unit dynamically varies specific inspection parameters for each variant for the relative mass inspection of each of the inspection objects by the X-ray inspection device in accordance with the image feature value for each variant of each of the inspection objects recognized by the variant feature image recognition unit.

3. The X-ray inspection device according to claim 1,
wherein the variant feature image recognition unit detects the image feature value for each variant, by which the content component type of the inspection object is specifiable, from the classification image data by using an object detection method, and the inspection control unit recognizes the variant of the inspection object based on the image feature value for each variant, and varies the specific inspection parameters for the relative mass inspection in accordance with the content component type of the inspection object specified by the variant.

4. The X-ray inspection device according to claim 1,
wherein the variant feature image recognition unit detects an image of a two-dimensional code from the classification image data, and the inspection control unit recognizes the variant of the inspection object by performing predetermined code reading processing of reading the two-dimensional code, and varies the specific inspection parameters for the relative mass inspection in accordance with the content component type of the inspection object specified by the variant.

5. An article inspection system comprising:
the X-ray inspection device according to claim 1,
wherein the morphological feature imaging unit is mounted on an appearance inspection device disposed upstream of the X-ray inspection device, and the classification image data, including the classifiable morphological features of the inspection object, transmitted as output from the appearance inspection device is received as input by the inspection control unit of the X-ray inspection device.

6. The X-ray inspection device according to claim 2,
wherein the variant feature image recognition unit detects the image feature value for each variant, by which the content component type of the inspection object is specifiable, from the classification image data by using an object detection method, and the inspection control unit recognizes the variant of the inspection object based on the image feature value for each variant, and varies the specific inspection parameters for the relative mass inspection in accordance with the content component type of the inspection object specified by the variant.

7. The X-ray inspection device according to claim 2,
wherein the variant feature image recognition unit detects an image of a two-dimensional code from the classification image data, and the inspection control unit recognizes the variant of the inspection object by performing predetermined code reading processing of reading the two-dimensional code, and varies the specific inspection parameters for the relative mass inspection in accordance with the content component type of the inspection object specified by the variant.

8. An article inspection system comprising:
the X-ray inspection device according to claim 2,
wherein the morphological feature imaging unit is mounted on an appearance inspection device disposed upstream of the X-ray inspection device, and the classification image data, including the classifiable morphological features of the inspection object, transmitted as output from the appearance inspection device is received as input by the inspection control unit of the X-ray inspection device.

9. The X-ray inspection device according to claim 1,
wherein the specific inspection parameters are a correction exponent corresponding to X-ray intensity that attenuates exponentially during transmission through a material and a reference value of actual weight.

10. The X-ray inspection device according to claim 2,
wherein the specific inspection parameters are a correction exponent corresponding to X-ray intensity that attenuates exponentially during transmission through a material and a reference value of actual weight.
